(19) United States
(12) Patent Application Publication
(10) Pub. No.: US 2020/0249967 A1
(43) Pub. Date: Aug. 6, 2020

(54) INFORMATION REMINDING METHOD AND DEVICE, TERMINAL AND STORAGE MEDIUM

(71) Applicant: BEIJING DAJIA INTERNET INFORMATION TECHNOLOGY CO., LTD., Beijing (CN)

(72) Inventor: Yonglong SUN, Beijing (CN)

(21) Appl. No.: 16/855,424

(22) Filed: Apr. 22, 2020

(30) Foreign Application Priority Data
Apr. 22, 2019 (CN) 201910324930.5

(51) Int. Cl. G06F 9/451; G06F 9/54; G06F 3/0485; G06F 3/0486; G06F 3/0488; G06F 3/0482

(52) U.S. Cl. CPC G06F 9/453; G06F 9/542; G06F 3/0482; G06F 3/0486; G06F 3/04883; G06F 3/0485

(57) ABSTRACT

The disclosure provides an information reminding method and device, a terminal and a storage medium. The information reminding method includes: acquiring target data and a reminding identification, where the reminding identification has a corresponding relationship with the target data; generating a target object according to the target data; and outputting dynamic reminding information according to the reminding identification when the target object is displayed in a preset display region of the first terminal.

### CROSS REFERENCE TO RELATED APPLICATIONS

The present application claims the priority from Chinese Patent Application No. 201910324930.5, filed with the Chinese Patent Office on Apr. 22, 2019, and entitled “INFORMATION REMINDING METHOD AND DEVICE, TERMINAL AND STORAGE MEDIUM”, which is hereby incorporated by reference in its entirety.

### FIELD

The disclosure relates to the technical field of computers, in particular to an information reminding method and device, a terminal and a storage medium.

### BACKGROUND

With continuous development of the computer technology, mobile terminals are more and more widely used. A user often browses information by using an application on a mobile terminal, in order to facilitate information browsing of the user, most information applications usually display information to the user in a mode of an information list in an interface, where the information list includes a plurality of objects, each object is displayed in a view mode, different information contents are carried in each view, and the objects may be pictures, texts, videos and the like. Furthermore, the information list often contains lots of objects, so how to avoid the user missing the objects of interest has become a widespread concern.

In the prior art, a display style of an object interested by the user is usually changed, for example, a prompt icon is added to the object, or a conspicuous color is set for the object, so that the object is prominent in the whole information list, the probability that the user focuses on the object is improved, and the possibility that the object is ignored by the user is reduced.

However, when the styles of various objects in the information list are complicated, in the prior art, a mode of changing the styles of the objects cannot effectively arouse the attention of the user, so that the user may miss the interested content, and an information reminding effect is poor.

### SUMMARY

In order to solve the problems in the related art, the disclosure provides an information reminding method and device, a terminal and a storage medium.

According to a first aspect of an embodiment of the disclosure, an information reminding method is provided, applied to a first terminal and including:

acquiring target data and a reminding identification, where the reminding identification has a corresponding relationship with the target data;

generating a target object according to the target data; and

outputting dynamic reminding information according to the reminding identification when the target object is displayed in a preset display region of the first terminal.

In one possible implementation, the acquiring the target data and the reminding identification includes:

receiving the target data and the reminding identification transmitted by a server; or

receiving the target data transmitted by a second terminal, and generating the reminding identification according to importance degree of the second terminal with respect to the first terminal, where the second terminal is any terminal except the first terminal; or

fetching the target data and the reminding identification which are pre-stored in the first terminal.

In one possible implementation, after the target object is displayed in the preset display region of the first terminal, the method further includes:

reducing a sliding speed of an information list where the target object belongs, and

restoring the sliding speed of the information list to a default value when the target object slides to a region outside the preset display region.

In one possible implementation, an area of the preset display region is smaller than an area of a screen of the first terminal; and

before the dynamic reminding information is output according to the reminding identification when the target object is displayed in the preset display region of the first terminal, the method further includes:

detecting whether a superposition area of the target object and the preset display region reaches a maximum value; and

determining that the target object is displayed in the preset display region of the first terminal when the superposition area reaches the maximum value.

In one possible implementation, a distance between a center point of the preset display region and a center point of a screen of the first terminal is not greater than a preset distance threshold.

In one possible implementation, the detecting whether the superposition area of the target object and the preset display region reaches the maximum value includes:

acquiring intersection points of the target object and the preset display region;

determining the superposition area of the target object and the preset display region according to the intersection points; and

when the superposition area is not smaller than an area of the target object or the area of the preset display region, determining that the superposition area of the target object and the preset display region reaches the maximum value.

In one possible implementation, the reminding identification includes at least a reminding field and a reminding rank value; and

the outputting the dynamic reminding information according to the reminding identification includes:

acquiring the reminding rank value corresponding to the reminding field; and

outputting the dynamic reminding information with reminding intensity matched with the reminding rank value;

where the larger the reminding rank value is, the stronger the reminding intensity of the dynamic reminding information is, and the dynamic reminding information includes at least one of vibration reminding, sound reminding or dynamic animation reminding.

In one possible implementation, the generating the reminding identification according to importance degree of the second terminal with respect to the first terminal includes:

determining the importance degree of the second terminal with respect to the first terminal according to associated information of the second terminal and the first terminal, where the associated information includes one or more of intimacy grade, interaction frequency and interaction duration of the second terminal and the first terminal; and

taking a preset field as the reminding field, and setting a reminding rank value for the reminding field according to the importance degree, to obtain the reminding identification, where the reminding rank value is positively correlated with the importance degree.

According to a second aspect of the embodiment of the disclosure, an information reminding device is provided, applied to a first terminal and including:

a processor configured to read and execute program in a memory to:

acquire target data and a reminding identification, where the reminding identification has a corresponding relationship with the target data;

generate a target object according to the target data; and

output dynamic reminding information according to the reminding identification when the target object is displayed in a preset display region of the first terminal.

In one possible implementation, the processor is further configured to read and execute the program to:

receive the target data and the reminding identification transmitted by a server; or

receive the target data transmitted by a second terminal and generate the reminding identification according to importance degree of the second terminal with respect to the first terminal, where the second terminal is any terminal except the first terminal; or

fetch the target data and the reminding identification which are pre-stored in the first terminal.

In one possible implementation, the processor is further configured to read and execute the program to:

reduce a sliding speed of an information list where the target object belongs, and

restore the sliding speed of the information list to a default value when the target object slides to a region outside the preset display region.

In one possible implementation, an area of the preset display region is smaller than an area of a screen of the first terminal; and

the processor is further configured to read and execute the program to:

detect whether a superposition area of the target object and the preset display region reaches a maximum value; and

determine that the target object is displayed in the preset display region of the first terminal when the superposition area reaches the maximum value.

In one possible implementation, a distance between a center point of the preset display region and a center point of the screen of the first terminal is not greater than a preset distance threshold.

In one possible implementation, the processor is further configured to read and execute the program to:

acquire intersection points of the target object and the preset display region;

determine the superposition area of the target object and the preset display region according to the intersection points; and

when the superposition area is not smaller than an area of the target object or an area of the preset display region, determine that the superposition area of the target object and the preset display region reaches the maximum value.

In one possible implementation, the reminding identification includes at least a reminding field and a reminding rank value; and

the processor is further configured to read and execute the program to:

acquire the reminding rank value corresponding to the reminding field; and

output the dynamic reminding information with reminding intensity is matched with the reminding rank value;

where the larger the reminding rank value is, the stronger the reminding intensity of the dynamic reminding information is, and the dynamic reminding information includes at least one of vibration reminding, sound reminding or dynamic animation reminding.

In one possible implementation, the processor is further configured to read and execute the program to:

determine the importance degree of the second terminal with respect to the first terminal according to associated information of the second terminal and the first terminal, where the associated information includes one or more of intimacy grade, interaction frequency and interaction duration of the second terminal and the first terminal; and

take a preset field as a reminding field, and set the reminding rank value for the reminding field according to the importance degree to obtain the reminding identification, where the reminding rank value is positively correlated with the importance degree.

According to a third aspect of the embodiment of the disclosure, a terminal is provided, including:

a processor; and

a memory for storing instructions executed by the processor;

where the processor is configured to execute operations to implement the information reminding method as provided by the disclosure.

According to a fourth aspect of the embodiment of the disclosure, a non-temporary computer readable storage medium is provided, and the terminal executes the operations to implement the information reminding method as provided by the disclosure, when instructions in the storage medium are executed by the processor of the terminal.

According to a fifth aspect of the embodiment of the disclosure, an application is provided, where the application includes one or more instructions, when the one or more instructions are executed by the processor of the terminal, the terminal executes operations to implement the information reminding method as provided by the disclosure.

According to a sixth aspect of the embodiment of the disclosure, the disclosure further discloses an executable program code, where the executable program code is configured to be executed to perform the steps of the above information reminding method.

According to the technical solution provided by the embodiment of the disclosure, the disclosure has the following beneficial effects:

the first terminal acquire the target data and the reminding identification, where the reminding identification has the corresponding relationship with the target data, then the target object is generated according to the target data, and when the target object is displayed in the preset display region of the first terminal, the dynamic reminding information is output according to the reminding identification, so that a user is attracted, and the problem that information carried by the object is ignored by the user is avoided. Meanwhile, compared with a mode of only changing the style of the object in the prior art, the object is distinguished from other objects statically on visual effect, and the user is attracted in a static reminding mode, in the embodiment of the disclosure, when lots of the objects may be included in the information list, and the styles of the objects are complex, the user is reminded by outputting the dynamic reminding information, so that the other objects may be prevented from visually disturbing the attention of the user to the maximum extent, therefore, the user is attracted effectively, and an information reminding effect is improved.

It is to be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of the specification, illustrate embodiments consistent with the disclosure and, together with the specification, serve to explain the principles of the disclosure.

FIG. 1 is a flow diagram of an information reminding method illustrated according to an exemplary embodiment.

FIG. 2A is a flow diagram of another information reminding method illustrated according to an exemplary embodiment.

FIG. 2B is a schematic diagram of a preset display region provided by an embodiment of the disclosure.

FIG. 2C is a schematic diagram of an information list provided by the embodiment of the disclosure.

FIG. 2D is a schematic diagram of a screen provided by the embodiment of the disclosure.

FIG. 3 is a block diagram of an information reminding device illustrated according to an exemplary embodiment.

FIG. 4 is a block diagram of a terminal illustrated according to an exemplary embodiment.

FIG. 5 is a block diagram of another terminal illustrated according to an exemplary embodiment.

### DETAILED DESCRIPTION OF THE EMBODIMENTS

Reference will now be made in detail to exemplary embodiments, examples of which are illustrated in the accompanying drawings. When the following description refers to the accompanying drawings, like numerals in different accompanying drawings indicate the same or similar elements, unless otherwise indicated. The implementations described in the following exemplary embodiments do not represent all implementations consistent with the disclosure. Rather, they are merely examples of devices and methods consistent with some aspects of the disclosure as detailed in the appended claims.

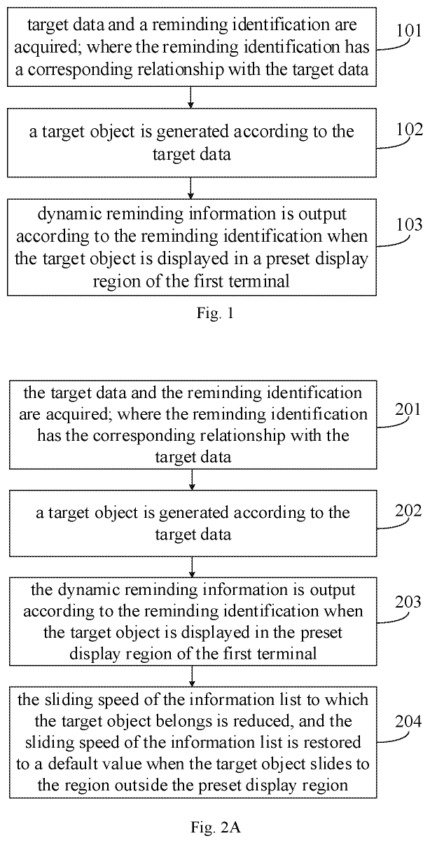

FIG. 1 is a flow diagram of an information reminding method illustrated according to an exemplary embodiment, and as shown in FIG. 1, the information reminding method is applied to a first terminal and includes the following steps:

step 101, target data and a reminding identification are acquired; where the reminding identification has a corresponding relationship with the target data.

In the embodiment of the disclosure, the target data may be data for displaying a certain object in an information list, the reminding identification may be added into the target data, may also be independent of the target data, and may be in one-to-one correspondence with only one target datum, that is, different target data corresponds to different reminding identifications, of course, the reminding identification may also correspond to the plurality of target data, that is, the reminding identifications corresponding to the multiple target data may be the same,; further, when acquiring the target data and the reminding identification, the first terminal may firstly acquire the target data and then acquire the reminding identification, may firstly acquire the reminding identification and then acquire the target data, and may also acquire the target data and the reminding identification simultaneously, and this is not limited in the embodiment of the disclosure.

Step 102, a target object is generated according to the target data.

In the embodiment of the disclosure, the first terminal may generate the target object by using the target data on the basis of a model view controller (MVC) architecture. The target object may be an object included in the information list.

Step 103, dynamic reminding information is output according to the reminding identification when the target object is displayed in a preset display region of the first terminal.

In the embodiment of the disclosure, the preset display region may be a region divided in advance on a screen of the first terminal, and the size and position of the preset display region may be set according to actual requirements; exemplary, the preset display region may be the entire screen of the first terminal, the preset display region may also be the upper half screen of the first terminal, and this is not limited in the embodiment of the disclosure.

Further, because lots of objects are often included in the information list, however, display regions of terminals are limited, thus, in the embodiment of the disclosure, when the target object is displayed in the preset display region of the first terminal, that is, when a user browses information by using the first terminal, the target object included in the information list may slide to the preset display region by sliding the information list, and thus when the target object may be viewed, the first terminal may output the dynamic reminding information according to the reminding identification which has the corresponding relationship with the target data; where the dynamic reminding information may be at least one of vibration reminding, sound reminding or dynamic animation reminding. Thus, when the other objects in the information list are also displayed in the screen, and the styles of the various objects are complex, the user is reminded by outputting the dynamic reminding information, so that the interference of the other objects on the attention of the user visually may be avoided to the maximum extent, the user is attracted effectively, and an information reminding effect is improved.

Exemplary, assuming that 8 objects in the information list are displayed on the screen, if only a reminding icon is added to the target object, the user may not notice the added reminding icon and miss the displayed target object due to the fact that lots of objects are displayed currently. Further, in the embodiment of the disclosure, when the displayed target object is displayed in the preset display region, the dynamic reminding information is output, for example, vibration reminding may be output when the target object is displayed in the preset display region, thus, even if the 7 other objects are displayed on the current screen and the user is visually disturbed, the user may also intuitively feel be reminded so as to attract the user, and the probability that the user misses the target object is reduced to a certain extent.

In summary, the embodiment of the disclosure provides the information reminding method, the first terminal may acquire the target data and the reminding identification, where the reminding identification has the corresponding relationship with the target data; then the target object may be generated according to the target data; and when the target object is displayed in the preset display region of the first terminal, the dynamic reminding information is output according to the reminding identification, so that the user is attracted, and the problem that information carried by the object is ignored by the user is avoided. Meanwhile, compared with a mode of only changing the style of the object in the prior art, the object is distinguished from the other objects statically on visual effect, and the user is attracted in a static reminding mode, in the embodiment of the disclosure, when lots of objects may be included in the information list, and the styles of the objects are complex, the user is reminded by outputting the dynamic reminding information, so that the other objects may be prevented from visually disturbing the attention of the user to the maximum extent, therefore, the user is attracted effectively, and the information reminding effect is improved.

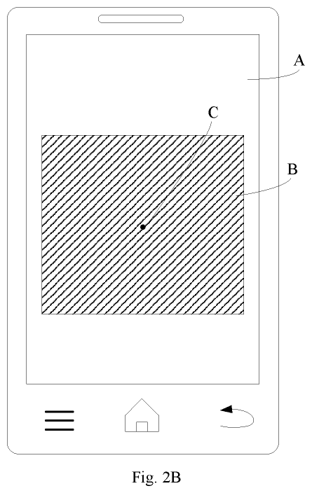

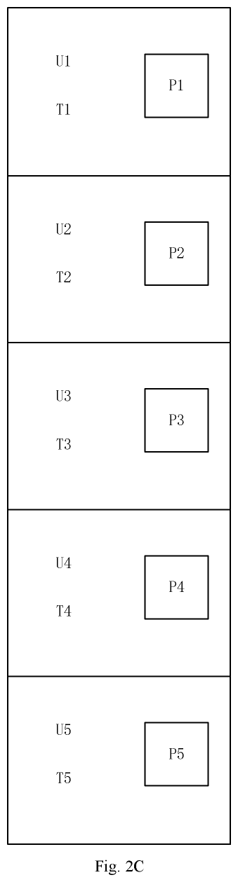

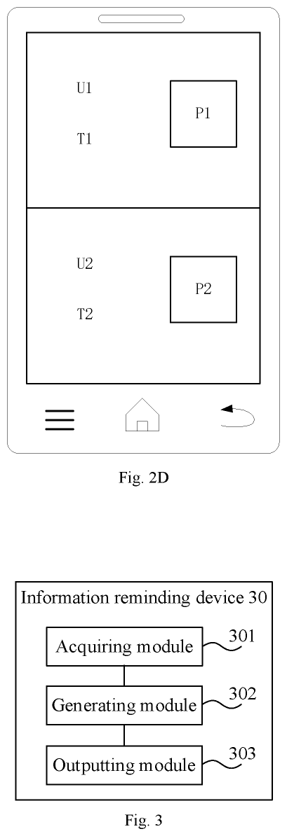

FIG. 2A is a flow diagram of another information reminding method illustrated according to an exemplary embodiment, as shown in FIG. 2A, the information reminding method includes the following steps:

step 201, the target data and the reminding identification are acquired; where the reminding identification has the corresponding relationship with the target data.

Specifically, the step may also be implemented through the following step 2011:

step 2011, the target data transmitted by a second terminal is received, and the reminding identification is generated according to the importance degree of the second terminal with respect to the first terminal.

In the step, the second terminal may be any terminal except the first terminal, and the second terminal may transmit the target data to the first terminal on the basis of the address of the first terminal; the reminding identification may further include a reminding field and a reminding rank value, and accordingly, the reminding identification may be generated through the following substeps (1) and (2):

substep (1): the importance degree of the second terminal with respect to the first terminal is determined on the basis of associated information of the second terminal and the first terminal.

In the step, the importance degree may be information reflecting closeness of connection between the second terminal and the first terminal; the larger the closeness of the connection between the second terminal and the first terminal is, the larger the importance degree between the second terminal and the first terminal is; and the associated information may include at least one or more of intimacy level, interaction frequency or interaction duration of the second terminal and the first terminal; where the intimacy level may be a label preset by the user, exemplary, the label may be a ‘family member’ with high intimacy level, a ‘friend’ with low intimacy level and the like, and this is not limited in the embodiment of the disclosure. Furthermore, the interaction frequency and the interaction duration may be the frequency and duration of interaction of the second terminal and the first terminal within a preset duration, specifically, if the associated information of the second terminal with respect to the first terminal is higher, the second terminal and the first terminal may be considered to be more closely connected; the higher the importance degree of the second terminal with respect to the first terminal is, the larger the possibility that the user of the second terminal is interested in contents transmitted by the first terminal is, and therefore, the importance degree may be determined according to the principle that the importance degree is positively correlated with the associated information. It should be noted that the specific content of the associated information may be set according to the actual requirements, and exemplary, the associated information may be the information capable of reflecting the closeness of the connection between the second terminal and the first terminal, and the associated information may also be a degree of concern, which is pre-defined by the user, of the second terminal and the first terminal, and the a degree of concern may reflect the level of concern of the user of the first terminal to the information transmitted by the second terminal.

Substep (2): a preset field is taken as the reminding field, and the reminding rank value is set for the reminding field according to the importance degree to obtain the reminding identification.

Exemplary, the preset field may be pre-defined by a developer, and exemplary, the preset field may be defined as ‘alert level’. Accordingly, the first terminal may take the preset field ‘alert level’ as the reminding field; further, the reminding rank value may be integer data, exemplary, the reminding rank value may be int-type data. Further, the reminding rank value may be positively correlated with the importance degree, specifically, when the reminding rank value is set, of the larger the importance degree of the second terminal with respect to the first terminal is, the larger reminding rank value may be set; and the smaller the importance degree of the second terminal with respect to the first terminal is, the smaller reminding rank value may be set; exemplary, assuming that the importance degree is 2, a corresponding reminding rank value with the reminding intensity of 2 may be set, and assuming that the importance degree is 0, a corresponding reminding rank value with the reminding intensity of 0 may be set, that is, no dynamic reminding is made.

Further, taking the reminding identification added in the target data as an example, when the reminding identification is generated, the reminding identification may be added at a designated adding position of the target data; where the designated adding position may be pre-defined according to the actual situation. In order to ensure that the first terminal may normally display the object on the basis of the added target data, in the embodiment of the disclosure, after the reminding identification is selectively added, the position, of the operation of the target object displayed on the basis of the target data in the subsequent step, is taken as the designated adding position which may not be affected, and exemplary, the designated adding position may be the tail end of the target data, and may also be the head end of the target data, and this is not limited in the embodiment of the disclosure.

Furthermore, in the embodiment of the disclosure, by setting different reminding intensity values for the target data with different importance degree, the first terminal may output the dynamic reminding information of which the reminding intensity is matched with the reminding rank value on the basis of the reminding rank value in the reminding identification in the subsequent step; where the reminding intensity is positively correlated with the reminding rank value, so that reminding with different intensities may be carried out according to the different importance degree, and the possibility that the information with high importance degree is missed is reduced as much as possible.

Further, the step may also be implemented by the following step 2012:

step 2012, the target data and the reminding identification which are transmitted by a server are received.

In the step, the target data and the reminding identification which are transmitted by the server may be transmitted to the server by another terminal, and may also be pre-stored in the server; exemplary, the server may be a server of a certain application, and a developer of the application may pre-store the target data and the reminding identification in the server; where the reminding rank value in the reminding identification may be determined on the basis of the importance degree, and may also be determined on the basis of other information, for example, the reminding rank value in the reminding identification is set on the basis of business requirements of the application, and the like. Furthermore, the address of the first terminal may be pre-stored in the server, so that the server may transmit the target data and the reminding identification to the first terminal according to the pre-stored address.

Further, the step may also be implemented by the following step 2013:

step 2013, the target data and the reminding identification which are pre-stored in the first terminal are fetched.

In the embodiment of the disclosure, the target data and the reminding identification may be pre-stored in the first terminal, and accordingly, the target data and the reminding identification may be acquired by the first terminal through fetching.

Step 202, a target object is generated according to the target data.

Specifically, the implementation of the step may refer to step 102 described above, and it is not described in detail herein in the embodiment of the disclosure.

Step 203, the dynamic reminding information is output according to the reminding identification when the target object is displayed in the preset display region of the first terminal.

In the embodiment of the disclosure, the first terminal may first judge whether the target object is displayed in the preset display region of the first terminal or not through the following step A to step B:

step A, whether the superposition area of the target object and the preset display region reaches a maximum value or not is detected.

In the step, the area of the preset display region may be smaller than the area of the screen of the first terminal, thus, reminding when the target object is displayed on the screen of the first terminal may be avoided, and then the reminding accuracy may be improved. Further, the distance between the center point of the preset display region and the center point of the screen of the first terminal may be not greater than a preset distance threshold, where the preset distance threshold may be preset according to the actual requirements, and the specific value of the preset distance threshold may be a numeric value by which the preset display region is close to the center of the screen of the first terminal; exemplary, the preset distance threshold may be 0.3 centimeter, and the preset distance threshold may also be 0.5 centimeter. It should be noted that the numeric value of the preset distance threshold may be set to be small in order to enable the preset display region to be positioned in the center of the screen of the first terminal as much as possible. Exemplary, the preset distance threshold is zero and the distance between the center points is equal to the preset distance threshold, that is, the center point of the preset display region is superposed to the center point of the screen of the first terminal, FIG. 2B is a schematic diagram of the preset display region provided by the embodiment of the disclosure, as shown in FIG. 2B, A represents the screen of the first terminal, the area B covered by oblique lines represents the preset display region, the point C represents the center point of the preset display region and the center point of the screen of the first terminal, and it can be seen that the center point of the preset display region is superposed to the center point of the screen of the first terminal, and the area of the preset display region B is smaller than the area of the screen A of the first terminal.

Because the probability that the content in the center of the screen is noticed by the user is large, the distance between the center point of the preset display region and the center point of the screen of the first terminal is not larger than the preset distance threshold in the embodiment of the disclosure. The probability that the target object is noticed by the user when reminding is carried out while the target object is displayed in the preset display region in the subsequent step may be increased, and the reminding efficiency is further improved.

Further, the first terminal may detect whether the superposition area of the target object and the preset display region reaches the maximum value or not through the following substep (3) to substep (5):

substep (3): intersection points of the target object and the preset display region are acquired.

In the embodiment of the disclosure, the information list usually includes the plurality of objects, the area of the screen of the first terminal is limited, and therefore, in an actual application scene, the user often slides the information list to continuously adjust the objects displayed in the screen so as to browse the objects included in the information list. Exemplary, the target data corresponding to each object in the information list includes: a user name field, a published text field, a picture link field and a reminding identification, FIG. 2C is a schematic diagram of the information list provided by the embodiment of the disclosure, and as shown in FIG. 2C, the information list includes five objects: D1, D2, D3, D4 and D5, where a user name U1, a published text T1 and a picture P1 are displayed in D1, a user name U2, a published text T2 and a picture P2 are displayed in D2, a user name U3, a published text T3 and a picture P3 are displayed in D3, and a user name U4, a published text T4 and a picture P4 are displayed in D4, and a user name U5, a published text T5 and a picture P5 are displayed in D5.

Further, FIG. 2D is a schematic diagram of the screen provided by embodiment of the disclosure, and as shown in FIG. 2D, the screen displays part of objects in the information list: D1 and D2. Accordingly, when the user browses the information list, the other objects, such as D3 and D4, included in the information list displayed in the screen may be controlled by sliding the information list displayed in the screen.

Further, it can be seen that each object in the information list occupies a certain area in the screen, and therefore, as the user browses the various objects in the information list, the user may slide the target object in the information list into the preset display region, and the intersection points may be generated between the target object and the preset display region in the sliding process, so that the first terminal may acquire the intersection points between the target object and the preset display region, and the intersection points are used as the basis for calculating the superposition area. Exemplary, a preset point may be used as the origin of a coordinate system, for example, the vertex at the top left corner of the preset display region is used as the origin, a horizontal direction is taken as a horizontal axis, and a vertical direction is taken as a vertical axis to establish a reference coordinate system, then coordinates of different points in the preset display region and coordinates of the different points in the target object are determined, accordingly, when the coordinates of the preset display region intersect with the coordinates of the target object, it determines that the intersection points may exist between the target object and the preset display region, and at the moment, points represented by the intersecting coordinates may be taken as the intersection points.

Substep (4): the superposition area of the target object and the preset display region is determined on the basis of the intersection points.

In the step, the first terminal may calculate the area of a closed space formed by all the intersection points so as to obtain the superposition area of the target object and the preset display region.

Substep (5): if the superposition area is not smaller than the area of the target object or the area of the preset display region, the first terminal determines that the superposition area of the target object and the preset display region reaches the maximum value.

In the step, because the area of the target object may be larger than the area of the preset display region, may be smaller than the area of the preset display region, or may be equal to the area of the preset display region, so that through the first terminal, it can be considered that the superposition area reaches the maximum value when the superposition area is not smaller than the area of the target object or the area of the preset display region. Exemplary, assuming that the area of the target object is X1 and the area of the preset display region is X2, where X1 is greater than X2, and it can be determined that the superposition area reaches the maximum value when the superposition area is not smaller than X2.

In the embodiment of the disclosure, the superposition area which is not smaller than the area of the target object or the area of the preset display region is used as a basis for judging whether the superposition area reaches the maximum value or not, so that the preset display region may be preset without being limited by the area of the target object, the freedom degree of setting the preset display region is further improved, the adaptability of the information reminding method in the embodiment of the disclosure is improved, and the adaptability limitation is reduced.

Step B, if the superposition area reaches the maximum value, the first terminal determines that the target object is displayed in the preset display region of the first terminal.

In the embodiment of the disclosure, when the superposition area of the target object and the preset display region of the first terminal reaches the maximum value, it can be considered that the target object is displayed in the preset display region to the maximum extent, and at the moment, it can be considered that the target object is displayed in the preset display region.

Further, when the first terminal determines that the target object is displayed in the preset display region of the first terminal, the dynamic reminding information may be output according to the reminding identification in accordance with the following substep (6) to substep (7):

substep (6): the reminding rank value corresponding to the reminding field is acquired.

Exemplary, taking the reminding identification added in the target data as a example, the first terminal may firstly locate the reminding field from the target data, and then the reminding rank value corresponding to the reminding field is read. Of course, if the reminding identification is not added into the target data, the reminding rank value corresponding to the reminding field in the reminding identification may be directly read.

Substep (7): the dynamic reminding information of which the reminding intensity is matched with the reminding rank value is output.

In the step, the larger the reminding rank value is, the stronger the reminding intensity of the dynamic reminding information is, and the dynamic reminding information may include at least one of vibration reminding, sound reminding or dynamic animation reminding. Exemplary, if the dynamic reminding information is sound reminding, then the reminding intensity of the dynamic reminding information may be the volume of the sound reminding, accordingly, the larger the reminding rank value is, the larger the volume is, for example, when the reminding rank value is 1, the sound reminding with the volume of 3 may be output, and when the reminding rank value is 2, the sound reminding with the volume of 6 may be output. Further, if the dynamic reminding information is vibration reminding, then the reminding intensity of the dynamic reminding information may be the vibration intensity of the vibration reminding, accordingly, the larger the reminding rank value is, the stronger the vibration intensity is. If the dynamic reminding information is animation reminding, then the reminding intensity of the dynamic reminding information may be the motion speed of the animation reminding, and accordingly, the larger animation reminding is, the larger the motion speed is.

According to the embodiment of the disclosure, the dynamic reminding information of which the reminding intensity is matched with the reminding rank value is output, where the reminding rank value is positively correlated with the importance degree, and the reminding intensity is positively correlated with the reminding rank value, so that reminding with the different intensities may be carried out on different target data, and the possibility that the information with high importance degree is missed is reduced as much as possible.

Step 204, the sliding speed of the information list to which the target object belongs is reduced, and the sliding speed of the information list is restored to a default value when the target object slides to the region outside the preset display region.

In the actual application scene, the user often slides the information list through a dragging operation so as to control the specific object displayed in the screen, where the information list may be a UITableView control based on an Apple iOS operating system or a ListView control based on an Android operating system. Specifically, when the user slides the information list through the dragging operation, the first terminal may simulate a physical mechanical principle, the sliding speed of the information list is changed according to the dragging operation of the user, the sliding speed of the information list is gradually reduced at a preset deceleration accelerated speed in the sliding process, and finally, the information list stops.

Correspondingly, in the step, the sliding speed of the information list to which the target object belongs may be reduced after the dynamic reminding information is output, exemplary, the reduction degree of the sliding speed may be increased by increasing the preset deceleration accelerated speed, and then the sliding speed is reduced, so that the display time of the target object in the screen may be prolonged by reducing the sliding speed of the information list to which the target object belongs, the probability that the target object is concerned by the user is increased, and the reminding effect is further improved.

Further, the first terminal may restore the sliding speed of the information list to the default value when the target object slides to the region outside the preset display region; and thus, it can be ensured that the user may normally browse the other objects in the information list by restoring the sliding speed to the default value, and it ensures that the browsing efficiency is not affected when the user browses the other objects in the information list.

In summary, the embodiment of the disclosure provides another information reminding method, the first terminal may acquire the target data and the reminding identification, where the reminding identification has the corresponding relationship with the target data; the first terminal may then generate the target object according to the target data; and when the target object is displayed in the preset display region of the first terminal, the dynamic reminding information is output according to the reminding identification. Compared with the mode of only changing the style of the object in the prior art, the object is distinguished form the other objects statically on visual effect, and the user is attracted in the static reminding mode, in the embodiment of the disclosure, when lots of objects may be included in the information list, and the styles of the objects are complex, the user is reminded by outputting the dynamic reminding information, so that the other objects may be prevented from visually disturbing the attention of the user to the maximum extent, therefore, the user is attracted effectively, and the information reminding effect is improved. Meanwhile, the first terminal may prolong the display time of the target object in the screen by reducing the sliding speed of the information list to which the target object belongs, then the probability that the target object is concerned by the user is increased, the reminding effect is further improved, and it ensures that the browsing efficiency is not affected when the user browses the other objects in the information list.

FIG. 3 is a block diagram of an information reminding device illustrated according to an exemplary embodiment, the device 30 may be applied to the first terminal, and as shown in FIG. 3, the device 30 may include:

an acquiring module 301, configured to acquire the target data and the reminding identification, where the reminding identification has the corresponding relationship with the target data;

a generating module 302, configured to generate the target object according to the target data; and

an outputting module 303, configured to output the dynamic reminding information according to the reminding identification when the target object is displayed in the preset display region of the first terminal.

Where, the generating module 302 is connected with the acquiring module 301, and the outputting module 303 is connected with the generating module 302.

The device provided by the embodiment of the disclosure may acquire the target data and the reminding identification, where the reminding identification has the corresponding relationship with the target data; then the target object may be generated according to the target data; and when the target object is displayed in the preset display region of the first terminal, the dynamic reminding information is output according to the reminding identification, so that the user is attracted, and the problem that the information carried by the object is ignored by the user is avoided. Meanwhile, compared with the mode of only changing the style of the object in the prior art, the object is distinguished from the other objects statically on visual effect, and the user is attracted in the static reminding mode; in the embodiment of the disclosure, when lots of objects may be included in the information list, and the styles of the objects are complex, the user is reminded by outputting the dynamic reminding information, the other objects may be prevented from visually disturbing the attention of the user to the maximum extent, therefore, the user is attracted effectively, and the information reminding effect is improved.

In one possible implementation, the acquiring module 301 includes:

a receiving sub-module, configured to receive the target data and the reminding identification which are transmitted by the server; or

a generating sub-module, configured to receive the target data transmitted by the second terminal and generate the reminding identification according to the importance degree of the second terminal with respect to the first terminal; where the second terminal is any terminal except the first terminal; or

a fetching sub-module, configured to fetch the target data and the reminding identification which are pre-stored in the first terminal. Where the generating sub-module is connected with the receiving sub-module, and the fetching sub-module is connected with the generating sub-module.

In one possible implementation, the device 30 further includes:

a reducing module, configured to reduce the sliding speed of the information list to which the target object belongs, and a restoring module, configured to restore the sliding speed of the information list to the default value when the target object slides to the region outside the preset display region. The reducing module may be connected to the outputting module 303.

In one possible implementation, the area of the preset display region is smaller than the area of the screen of the first terminal; and

the device 30 further includes:

a detection module, configured to detect whether the superposition area of the target object and the preset display region reaches the maximum value; and

a determination module, configured to determine that the target object is displayed in the preset display region of the first terminal when the superposition area reaches the maximum value. The detection module may be connected to the generating module 302 and the determination module separately, and the determination module may be connected to the outputting module 303.

In one possible implementation, the distance between the center point of the preset display region and the center point of the screen of the first terminal is not greater than the preset distance threshold.

In one possible implementation, the detection module is configured to:

acquire the intersection points of the target object and the preset display region;

determine the superposition area of the target object and the preset display region according to the intersection points; and

determine that the superposition area of the target object and the preset display region reaches the maximum value when the superposition area is not smaller than the area of the target object or the area of the preset display region.

In one possible implementation, the reminding identification includes at least the reminding field and the reminding rank value;

the outputting module 303 is configured to:

acquire the reminding rank value corresponding to the reminding field; and

output the dynamic reminding information of which the reminding intensity is matched with the reminding rank value;

where the larger the reminding rank value is, the stronger the reminding intensity of the dynamic reminding information is, and the dynamic reminding information includes at least one of vibration reminding, sound reminding or dynamic animation reminding.

In one possible implementation, the generating sub-module is configured to:

determine the importance degree of the second terminal with respect to the first terminal according to the association information of the second terminal and the first terminal, where the associated information includes one or more of intimacy grade, interaction frequency and interaction duration of the second terminal and the first terminal; and

take the preset field as the reminding field, and set the reminding rank value for the reminding field according to the importance degree to obtain the reminding identification; where the reminding rank value is positively correlated with the importance degree.

With regard to the device in the foregoing embodiment, the specific mode in which the various modules perform operations has been described in detail in connection with the embodiment of the method, and it will not be described in detail herein.

According to another embodiment of the disclosure, a terminal is provided, including:

a processor; and

a memory for storing instructions executed by the processor;

where the processor is configured to execute operations to implement the information reminding method as provided by the disclosure.

According to another embodiment of the disclosure, a non-temporary computer readable storage medium is provided, and the terminal executes the operations to implement the information reminding method as provided by the disclosure, when instructions in the storage medium are executed by the processor of the terminal.

According to another embodiment of the disclosure, an application is provided, where the application includes one or more instructions, when the one or more instructions are executed by the processor of the terminal, the terminal executes operations to implement the information reminding method as provided by the disclosure.

According to another embodiment of the disclosure, the disclosure further discloses an executable program code, where the executable program code is configured to be executed to perform the steps of the above information reminding method.

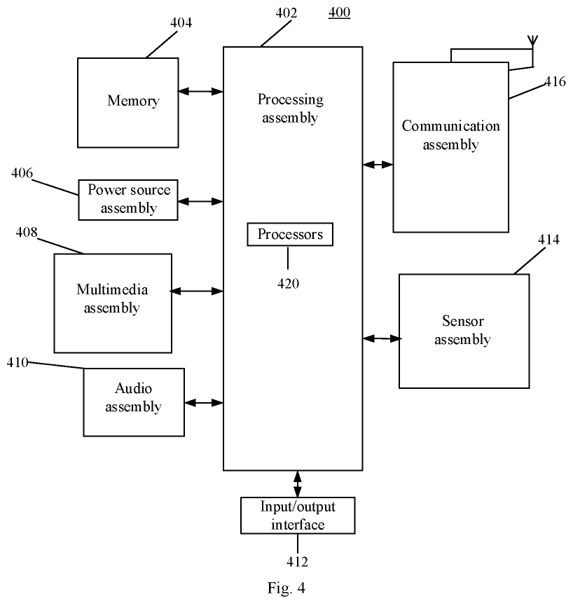

FIG. 4 is a block diagram of a terminal illustrated according to an exemplary embodiment. For example, the terminal 400 may be a mobile phone, a computer, a digital broadcast terminal, message receiving and transmitting equipment, a game console, a tablet device, medical equipment, fitness equipment, a personal digital assistant and the like.

Referring to FIG. 4, the terminal 400 may include one or more of the following assemblies: a processing assembly 402, a memory 404, a power source assembly 406, a multimedia assembly 408, an audio assembly 410, an input/output (I/O) interface 412, a sensor assembly 414 and a communication assembly 416.

The processing assembly 402 generally controls overall operation of the terminal 400, such as operations associated with display, telephone call, data communication, camera operation and recording operation. The processing assembly 402 may include one or more processors 420 to execute instructions so as to complete all or part of the steps of the foregoing method. In addition, the processing assembly 402 may include one or more modules to facilitate interaction between the processing assembly 402 and the other assemblies. For example, the processing assembly 402 may include a multimedia module to facilitate interaction between the multimedia assembly 408 and the processing assembly 402.

The memory 404 is configured to store various types of data to support operation at the terminal 400. Examples of these data include instructions for any application or method operating on the terminal 400, contact data, phonebook data, messages, pictures, video and the like. The memory 404 may be implemented by any type of volatile or nonvolatile storage equipment or combination thereof, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk or an optical disk.

The power source assembly 406 provides power to the various assemblies of the terminal 400. The power source assembly 406 may include a power management system, one or more power sources and the other assemblies associated with generation, management and distribution of power for the terminal 400.

The multimedia assembly 408 includes a screen which provides an output interface between the terminal 400 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touch, sliding and gestures on the touch panel. The touch sensor may not only sense the boundaries of a touch or sliding action, but also detect the duration and pressure which are associated with the touch or sliding operation. In some embodiments, the multimedia assembly 408 includes a front camera and/or a rear camera. When the terminal 400 is in an operation mode, such as a photographing mode or a video mode, the front camera and/or the rear camera may receive external multimedia data. Each of the front camera and the rear camera may be a fixed optical lens system or have focal length and optical zoom capabilities.

The audio assembly 410 is configured to output and/or input audio signals. For example, the audio assembly 410 includes a microphone (MIC) configured to receive the external audio signals when the terminal 400 is in an operation mode, such as a call mode, a recording mode and a voice recognition mode. The received audio signals may be further stored in the memory 404 or transmitted via the communication assembly 416. In some embodiments, the audio assembly 410 also includes a speaker for outputting the audio signals.

The I/O interface 412 provides an interface between the processing assembly 402 and a peripheral interface module, and the peripheral interface module may be a keyboard, a click wheel, buttons and the like. These buttons may include, but are not limited to, a home button, a volume button, a start button and a locking button.

The sensor assembly 414 includes one or more sensors for providing status assessments of various aspects for the terminal 400. For example, the sensor assembly 414 may detect the on/off state of the terminal 400 and relative positioning of the assemblies, for example, the assemblies are a display and a keypad of the terminal 400, the sensor assembly 414 may also detect a change in the position of the terminal 400 or one of the assemblies of the terminal 400, detect whether the user is in contact with the terminal 400 or not, and detect the orientation or acceleration/deceleration of the terminal 400 and a change in the temperature of the terminal 400. The sensor assembly 414 may include a proximity sensor configured to detect the presence of a nearby object under the condition that any physical contact does not exist. The sensor assembly 414 may also include a light sensor such as a CMOS or CCD image sensor which is used in imaging. In some embodiments, the sensor assembly 414 may also include an acceleration sensor, a gyro sensor, a magnetic sensor, a pressure sensor, or a temperature sensor.

The communication assembly 416 is configured to facilitate wired or wireless communication between the terminal 400 and other equipment. The terminal 400 may access a wireless network based on a communication standard, such as WiFi, an operator network (for example, 2G, 3G, 4G or 5G), or a combination thereof. In one exemplary embodiment, the communication assembly 416 receives broadcast signals or broadcast-related information from an external broadcast management system via a broadcast channel. In one exemplary embodiment, the communication assembly 416 further includes a near field communication (NFC) module to facilitate short-range communication. For example, the NFC module may be implemented based on a radio frequency identification (RFID) technology, an infrared data association (IrDA) technology, an ultra-wide band (UWB) technology, a Bluetooth (BT) technology and other technologies.

In an exemplary embodiment, the terminal 400 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components for carrying out the steps of the foregoing information reminding method when the terminal 400 is provided as the foregoing first terminal.

In an exemplary embodiment, a non-temporary storage medium including the instructions is further provided, such as the memory 404 including the instructions which may be executed by the processors 420 of the terminal 400 to complete the foregoing information reminding method. For example, the non-temporary storage medium may be an ROM, a random access memory (RAM), a CD-ROM, a magnetic tape, a floppy disk, optical data storage equipment and the like.

In an exemplary embodiment, the embodiment of the disclosure also provides an application including the one or more instructions, when the one or more instructions are executed by the processors of the terminal, the terminal may execute the operation executed to implement the information reminding method as provided by the disclosure.

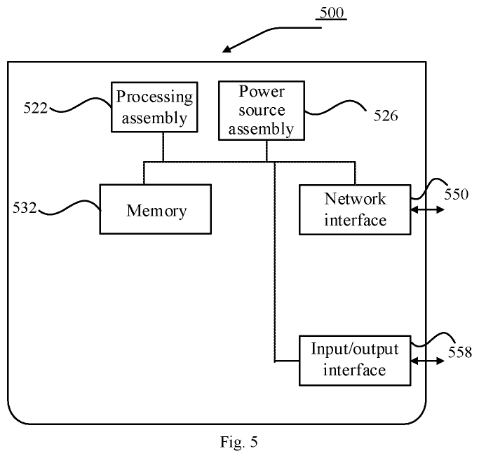

FIG. 5 is a block diagram of another terminal shown according to an exemplary embodiment. Referring to FIG. 5, the terminal 500 includes a processing assembly 522 which further includes the one or more processors, and a memory resource represented by a memory 532 for storing the instructions, such as the application, executable by the processing assembly 522. The application stored in the memory 532 may include one or more modules, and each module corresponds to one group of the instructions. In addition, the processing assembly 522 is configured to execute the instructions to execute the steps in the foregoing information reminding method.

The terminal 500 may also include a power source assembly 526 and an input/output (I/O) interface 558, the power source assembly 526 is configured to carry out power management for the terminal 500, and a wired or wireless network interface 550 is configured to connect the terminal 500 with a network. The terminal 500 may operate an operating system stored in the memory 532, such as Windows Server™, Mac OS X™, Unix™, Linux™, FreeBSD™ or the like.

Other implementation solutions of the disclosure will be apparent to those skilled in the art from consideration of the specification and practice of the disclosure disclosed herein. The disclosure is intended to cover any variations, uses, or adaptations of the disclosure following the general principles of the disclosure and including common general knowledge or customary technical means in the art not disclosed in the disclosure. The specification and embodiments are considered as exemplary only, and a true scope and spirit of the disclosure are indicated by the following claims.

It is to be understood that the disclosure is not limited to the precise constructions described above and illustrated in the accompanying drawings, and that various modifications and changes may be made without departing from the scope thereof The scope of the disclosure is limited only by the appended claims.

What is claimed is:

1. An information reminding method, applied to a first terminal, and comprising:
acquiring target data and a reminding identification, wherein the reminding identification has a corresponding relationship with the target data;
generating a target object according to the target data; and
outputting dynamic reminding information according to the reminding identification when the target object is displayed in a preset display region of the first terminal.

2. The method according to claim 1, wherein the acquiring the target data and the reminding identification comprises:
receiving the target data and the reminding identification transmitted by a server; or
receiving the target data transmitted by a second terminal, and generating the reminding identification according to importance degree of the second terminal with respect to the first terminal, wherein the second terminal is any terminal except the first terminal; or
fetching the target data and the reminding identification which are pre-stored in the first terminal.

3. The method according to claim 1, wherein after the target object is displayed in the preset display region of the first terminal, the method further comprises:
reducing a sliding speed of an information list where the target object belongs, and
restoring the sliding speed of the information list to a default value when the target object slides to a region outside the preset display region.

4. The method according to claim 1, wherein an area of the preset display region is smaller than an area of a screen of the first terminal; and
before the dynamic reminding information is output according to the reminding identification when the target object is displayed in the preset display region of the first terminal, the method further comprises:
detecting whether a superposition area of the target object and the preset display region reaches a maximum value; and
determining that the target object is displayed in the preset display region of the first terminal when the superposition area reaches the maximum value.

5. The method according to claim 1, wherein a distance between a center point of the preset display region and a center point of a screen of the first terminal is not greater than a preset distance threshold.

6. The method according to claim 4, wherein the detecting whether the superposition area of the target object and the preset display region reaches the maximum value comprises:
acquiring intersection points of the target object and the preset display region;
determining the superposition area of the target object and the preset display region according to the intersection points; and
when the superposition area is not smaller than an area of the target object or the area of the preset display region, determining that the superposition area of the target object and the preset display region reaches the maximum value.

7. The method according to claim 1, wherein the reminding identification comprises at least a reminding field and a reminding rank value; and
the outputting the dynamic reminding information according to the reminding identification comprises:
acquiring the reminding rank value corresponding to the reminding field; and
outputting the dynamic reminding information with reminding intensity matched with the reminding rank value,
wherein the larger the reminding rank value is, the stronger the reminding intensity of the dynamic reminding information is, and the dynamic reminding information comprises at least one of vibration reminding, sound reminding or dynamic animation reminding.

8. The method according to claim 2, wherein the generating the reminding identification according to the importance degree of the second terminal with respect to the first terminal comprises:
determining the importance degree of the second terminal with respect to the first terminal according to associated information of the second terminal and the first terminal, wherein the associated information comprises one or more of intimacy grade, interaction frequency and interaction duration of the second terminal and the first terminal; and
taking a preset field as a reminding field, and setting a reminding rank value for the reminding field according to the importance degree, to obtain the reminding identification, wherein the reminding rank value is positively correlated with the importance degree.

9. An information reminding device, applied to a first terminal, and comprising:
a processor configured to read and execute program in a memory to:
acquire target data and a reminding identification, wherein the reminding identification has a corresponding relationship with the target data;
generate a target object according to the target data; and
output dynamic reminding information according to the reminding identification when the target object is displayed in a preset display region of the first terminal.

10. The device according to claim 9, wherein the processor is further configured to read and execute the program to:
receive the target data and the reminding identification transmitted by a server; or
receive the target data transmitted by a second terminal and generate the reminding identification according to importance degree of the second terminal with respect to the first terminal, wherein the second terminal is any terminal except the first terminal; or
fetch the target data and the reminding identification which are pre-stored in the first terminal.

11. The device according to claim 9, wherein the processor is further configured to read and execute the program to:
reduce a sliding speed of an information list where the target object belongs, and
restore the sliding speed of the information list to a default value when the target object slides to a region outside the preset display region.

12. The device according to claim 9, wherein an area of the preset display region is smaller than an area of a screen of the first terminal; and
the processor is further configured to read and execute the program to:
detect whether a superposition area of the target object and the preset display region reaches a maximum value; and
determine that the target object is displayed in the preset display region of the first terminal when the superposition area reaches the maximum value.

13. The device according to claim 9, wherein a distance between a center point of the preset display region and a center point of the screen of the first terminal is not greater than a preset distance threshold.

14. The device according to claim 12, wherein the processor is further configured to read and execute the program to:
acquire intersection points of the target object and the preset display region;
determine the superposition area of the target object and the preset display region according to the intersection points; and
when the superposition area is not smaller than an area of the target object or an area of the preset display region, determine that the superposition area of the target object and the preset display region reaches the maximum value.

15. The device according to claim 9, wherein the reminding identification comprises at least a reminding field and a reminding rank value; and
the processor is further configured to read and execute the program to:
acquire the reminding rank value corresponding to the reminding field; and
output the dynamic reminding information with reminding intensity matched with the reminding rank value;
wherein the larger the reminding rank value is, the stronger the reminding intensity of the dynamic reminding information is, and the dynamic reminding information comprises at least one of vibration reminding, sound reminding or dynamic animation reminding.

16. The device according to claim 10, wherein the processor is further configured to read and execute the program to:
determine the importance degree of the second terminal with respect to the first terminal according to associated information of the second terminal and the first terminal, wherein the associated information comprises one or more of intimacy grade, interaction frequency and interaction duration of the second terminal and the first terminal; and
take a preset field as a reminding field, and set a reminding rank value for the reminding field according to the importance degree to obtain the reminding identification, wherein the reminding rank value is positively correlated with the importance degree.

17. A terminal, comprising:
a processor; and
a memory for storing instructions executed by the processor;
wherein the processor is configured to execute operations to implement the information reminding method according to claim 1.

18. A non-temporary computer readable storage medium, wherein the terminal executes operations to implement the information reminding method according to claim 1 when instructions in the storage medium are executed by a processor of the terminal.

19. An executable program code, wherein the executable program code is configured to be executed to perform any one of the steps of the information reminding method in claim 1.
